(19) United States
(12) Patent Application Publication
(10) Pub. No.: US 2025/0289392 A1
(43) Pub. Date: Sep. 18, 2025

(54) CHAIR INCLUDING SEAT BELT DEVICE

(71) Applicants: Hyundai Motor Company, Seoul (KR); Kia Corporation, Seoul (KR); Hyundai Transys Inc., Seosan-si (KR)

(72) Inventors: Suk Won Hong, Bucheon-Si (KR); Mu Young Kim, Osan-Si (KR); Sang Hyun Lee, Anyang-Si (KR); Gil Ju Kim, Hwaseong-Si (KR); Sang Do Park, Seoul (KR); Ga Be Nam, Hwaseong-Si (KR); Hyun Ji Lee, Suwon-SI (KR); Hyung Rae Kim, Suwon-si (KR); Jeong Yong Yoo, Hwaseong-Si (KR); Gyung Do Park, Hwaseong-Si (KR); Dong Hwan Kim, Hwaseong-Si (KR)

(21) Appl. No.: 18/964,058

(22) Filed: Nov. 29, 2024

(30) Foreign Application Priority Data
Mar. 18, 2024 (KR) 10-2024-0037241

(51) Int. Cl. B60R 22/02; B60N 2/68; B60R 22/34

(52) U.S. Cl. CPC B60R 22/02; B60N 2/688; B60R 22/3408

(57) ABSTRACT

A seat belt device may be coupled to a frame of a chair. The seat belt device may include: a main body including a first gear and a second gear engaged with each other, a belt including a waist belt portion wound around the first gear and a shoulder belt portion extending from the waist belt portion and wound around the second gear, and a slider to which the belt is connected and slidably coupled to a portion of the frame.

### CROSS-REFERENCE TO RELATED APPLICATION(S)

This application claims benefit of priority to Korean Patent Application No. 10-2024-0037241 filed on Mar. 18, 2024 in the Korean Intellectual Property Office, the disclosure of which is incorporated herein by reference in its entirety.

### TECHNICAL FIELD

The present disclosure relates to a chair including a seat belt device, and more particularly, to a chair including a seat belt device provided in mobility devices including aircraft and vehicles.

### BACKGROUND

Mobility devices (e.g., vehicles) may be equipped with chairs for occupants to sit in. Such chairs may include a seat belt device to ensure the safety of occupants. There are various types of seat belt devices, and among them, a 4-point seat belt is a belt restraining the waist and shoulders and improves the restraint performance of occupants, compared to 2-point or 3-point seat belts.

Four-point seat belts of the related art have the disadvantage that a wearing process is cumbersome and complicated because an occupant should grip and fasten the belts on both sides of the waist and shoulders, respectively, based on the center of the main body, and since the waist belt and shoulder belt are located in the seat on which the occupant sits, there is inconvenience in having to adjust a position of the belt to sit.

### SUMMARY

The following summary presents a simplified summary of certain features. The summary is not an extensive overview and is not intended to identify key or critical elements.

Systems, apparatuses, and methods are described for a seat belt device and a chair and/or mobility device comprising the same. A device may comprise a frame configured to be coupled to a seat; and a seat belt device coupled to the frame. The seat belt device may comprise a main body comprising a first gear and a second gear engaged with each other; a belt comprising a waist belt portion wound around a first protrusion of the first gear and a shoulder belt portion extending from the waist belt portion and wound around a second protrusion of the second gear; and a slider, to which the belt is connected, slidably coupled to a portion of the frame.

A seat belt device may comprise a main body comprising a first gear and a second gear engaged with each other; a belt comprising a waist belt portion wound around a first protrusion of the first gear and a shoulder belt portion extending from the waist belt portion and wound around the second protrusion of second gear; and a slider, to which the belt is connected, slidably coupled to a guide rail. The shoulder belt portion may be configured to be unwound from the second protrusion of the second gear in conjunction with the waist belt portion being unwound from the first protrusion of the first gear. The slider may be configured to, by moving along the guide rail, move the shoulder belt portion to a wearing position.

A mobility device may comprise a body and a device and/or seat belt device as disclosed herein.

These and other features and advantages are described in greater detail below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a front perspective view of a chair including a seat belt device according to an example of the present disclosure;

FIG. 2 is a front perspective view of the chair including a seat belt device illustrated in FIG. 1 without a seat portion;

FIG. 3 is a rear perspective view of the chair including a seat belt device illustrated in FIG. 1 without a seat portion;

FIG. 4 is a perspective view illustrating a state in which a seat belt device is installed on a seat frame according to an example of the present disclosure;

FIG. 5 is a rear view illustrating a state in which a seat belt device is installed on a seat frame according to an example of the present disclosure;

FIG. 6 is a diagram illustrating a belt module of a seat belt device according to an example of the present disclosure;

FIG. 7 is a diagram illustrating a drive system of a seat belt device according to an example of the present disclosure;

FIG. 8 is a diagram illustrating an operation in which a slider of a seat belt device moves along a frame portion of a backrest frame according to an example of the present disclosure;

FIG. 9 is a front perspective view illustrating an operation in which a seat belt device is transformed between a basic state and a fastened state according to an example of the present disclosure;

FIG. 10 is a rear perspective view illustrating an operation in which a seat belt device is transformed between a basic state and a fastened state according to an example of the present disclosure; and

FIG. 11 is a diagram illustrating an operation in which a first gear and a second gear rotate based on a seat belt device being transformed between a basic state and a fastened state according to an example of the present disclosure.

### DETAILED DESCRIPTION

While the present disclosure may be modified in various ways and take on various alternative forms, specific examples thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc., may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe examples of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In this specification, an aircraft may refer to a mobility vehicle that can move by flying in the sky. That is, Also, or alternatively to referring to helicopters, drones, tilt rotors, fixed-wing airplanes, etc., aircraft may also include vehicles that move on the ground using wheels, etc., and can fly with the wheels, etc. separated from the ground. Also, or alternatively, aircraft may include manned aircraft and unmanned aircraft. Manned aircraft may include aircraft that can operate autonomously Also, or alternatively to aircraft controlled by a pilot.

Hereinafter, examples of the present disclosure will be described with reference to the drawings.

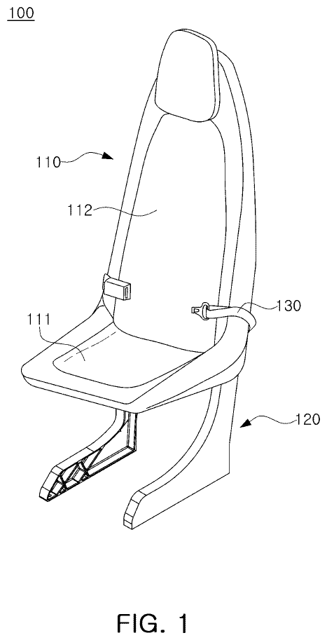

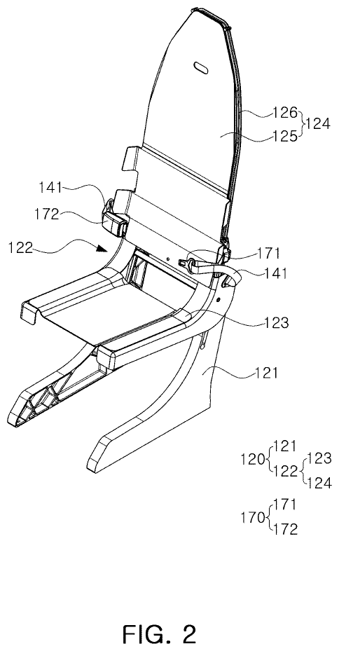

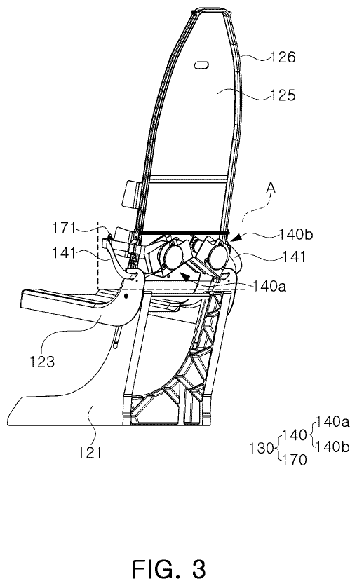

FIG. 1 is a front perspective view of a chair including a seat belt device according to an example of the present disclosure. FIG. 2 is a front perspective view of the chair including a seat belt device illustrated in FIG. 1 without a seat portion. FIG. 3 is a rear perspective view of the chair including a seat belt device illustrated in FIG. 1 without a seat portion.

FIGS. 2 and 3 illustrate the chair 100 illustrated in FIG. 1 without the seat 110 for clearly depicting various features, and/or as may be the case if the seat 110 is separated from the chair 100 or before the seat 110 is coupled to the chair 100.

The chair 100 according to an example may be installed in various types of mobility devices. As an example, the chair 100 may be installed in an aircraft. The chair 100 may be installed in a cabin inside an aircraft so that passengers on board the aircraft may sit. The aircraft may include, but is not limited to, an advanced air mobility (AAM), an urban air mobility (UAM), or a regional air mobility (RAM). The mobility device in which the chair 100 is installed is not limited to aircraft, and may include various types of mobility devices (e.g., vehicles, ships, etc.) in which passengers enter and seats are provided for the passengers.

Referring to FIGS. 1 to 3, the chair 100 according to an example may include a seat 110, a frame 120, and a seat belt device 130.

The seat 110 may be configured to contact a user's body and support the user's body if the user (or passenger) is seated. The seat 110 may include a seating portion 111 for supporting the user's buttocks and a backrest portion 112 for supporting the user's back. The seat 110 may be formed of a material having a cushioning feel, but is not limited thereto.

The seat 110 may be coupled to frame 120. For example, the seat 110 may be mounted and supported on the frame 120. The seat 110 may be coupled to the frame 120 to enable the seat belt device 130 of the chair 100 to operate. For example, the seat 110 may be coupled to the frame 120 so as not to restrict a withdrawal or retraction operation of a belt 141 from the seat belt device 130 according to an example.

The frame 120 may be a base structure or framework forming a skeleton (or frame) of the chair 100 and may support the seat 110 and the seat belt device 130. The seat 110 and the seat belt device 130 may be coupled to the frame 120. The frame 120 may support a load (e.g., if the user is seated). The frame 120 may be coupled to the floor of the interior of a vehicle (for example, a cabin of an aircraft or the interior of a car) in which the chair 100 is installed through various coupling members.

The frame 120 may include a leg frame 121 coupled to an installation surface and a seat frame 122 coupled to the leg frame 121 and on which the seat 110 is mounted.

The leg frame 121 may be coupled to the installation surface of the vehicle in which the chair 100 is provided. The leg frame 121 may be provided as a pair spaced apart from each other at a predetermined interval and arranged side by side, but is not limited thereto.

The seat frame 122 may be coupled to the leg frame 121 and supported. The seat 110 and the seat belt device 130 may be coupled to the seat frame 122. The seat frame 122 may include a seating portion frame 123 supporting the seating portion 111 of the seat 110 and a backrest frame 124 supporting the backrest portion 112 of the seat 110. The seat frame 122 may be provided in a form in which the seating portion frame 123 is coupled to the leg frame 121 and the backrest frame 124 is coupled to the seating portion frame 123.

The backrest frame 124 may include a plate portion 125 and a frame portion 126 coupled to the plate portion 125. For example, the frame portion 126 may be coupled to the frame portion 126 and surround at least a portion of an edge of the plate portion 125.

The seat belt device 130 may be coupled to the backrest frame 124. For example, a main body 142 of the seat belt device 130 may be coupled to the back (or rear) of the plate portion 125 of the backrest frame 124. Also, or alternatively, a slider 150 of the seat belt device 130 may be coupled to the frame portion 126 of the backrest frame 124.

The shape of the seat frame 122 is not limited to the illustrated example. According to various examples, the seat frame 122 may have a structure in which the seating portion frame 123 and the leg frame 121 are integrally formed.

The seat belt device 130 is a device to protect the user and ensure safety by restraining the movements of the user seated on the chair 100, and may be installed in the seat frame 122 of the chair 100 and may be fastened and released by a user operation.

The seat belt device 130 may be installed in the seat frame 122 such that the belt 141 extends across the seating portion frame 123 toward a front direction of the chair 100. For example, the belt 141 located on the seat 110 side may include a fastening member 170 (e.g., a clip 171 and/or a buckle 172).

The seat belt device 130 may include a first belt module 140a and a second belt module 140b. The belt 141 of the first belt module 140a may include a clip (and/or tongue) 171, and the buckle 172 may be provided in the belt 141 of the second belt module 140b, and the clip 171 may be fitted and coupled to the belt 141 of the second belt module 140b. The first belt module 140a and the second belt module 140b may be substantially the same in structure, configuration, shape, or operation, except for the type of the connected fastening member 170. The positions of the clip 171 and the buckle 172 are not limited to the illustrated example and may be reversed.

According to the illustrated example, a portion of the belt 141 drawn out from the first belt module 140a and a portion of the belt 141 drawn out from the second belt module 140b may form a waist belt according to fastening of the buckle 172 and the clip 171. Also, or alternatively, another portion of the belt 141 drawn out from the first belt module 140a may constitute a left shoulder belt restraining the user's left shoulder and chest, and another portion of the belt 141 drawn out from the second belt module 140b may constitute a right shoulder belt restraining the user's right shoulder and chest.

The seat belt device 130 according to an example may be a four-point belt restraining the waist and both shoulders of the user seated on the chair 100. For example, the seat belt device 130 may include a waist belt (not illustrated) surrounding and restraining the user's waist and a shoulder belt (not illustrated) extending toward the shoulder portion across the user's chest from the waist belt to surround and restrain both shoulder parts of the user.

The seat belt device 130 according to an example is an interlocking seat belt device having a structure in which the withdrawal and retraction operations of the waist belt and the shoulder belt are linked to each other, and as the shoulder belt is drawn out in conjunction with the withdrawal of the waist belt, the shoulder belt may be fastened together by the user withdrawing the waist belt and fastening the waist belt to the waist part of the user. Accordingly, the four-point belt may be fastened and worn by only a single action of fastening the waist belt, thereby improving user convenience.

Hereinafter, the components of the seat belt device 130 capable of providing the functions and effects described above will be described in detail.

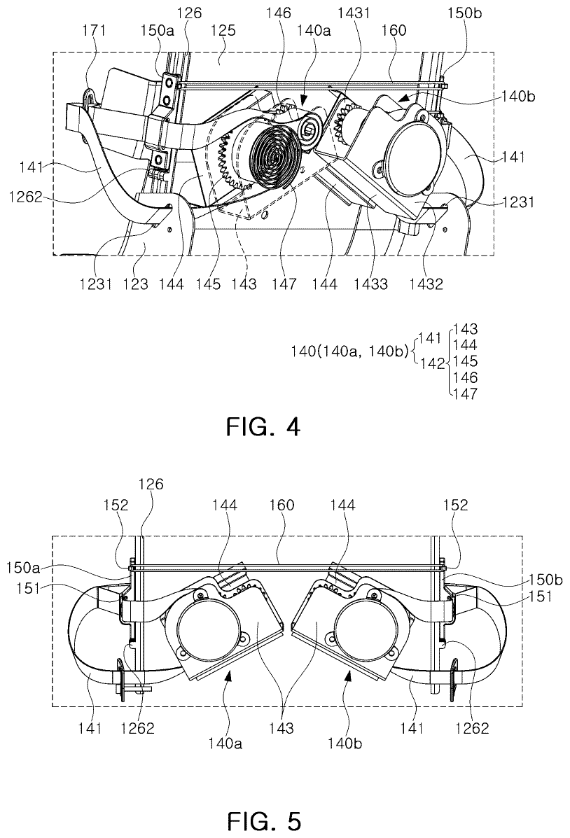

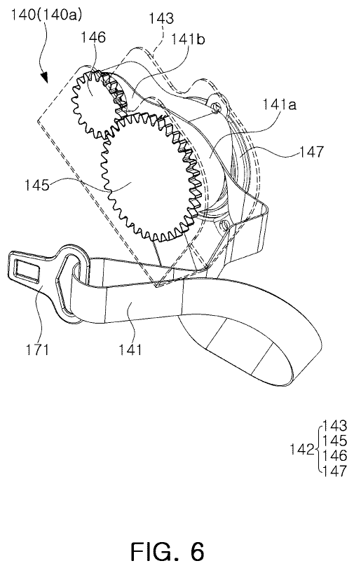

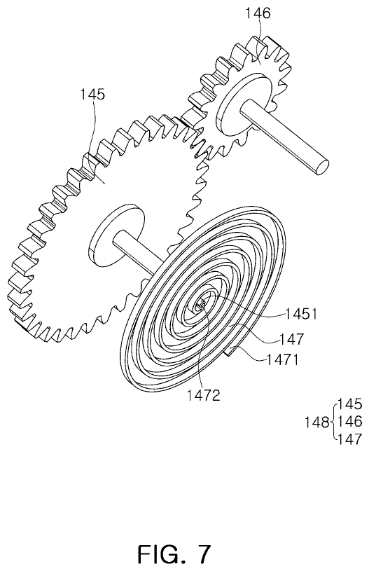

FIG. 4 is a perspective view illustrating a state in which a seat belt device is installed on a seat frame according to an example of the present disclosure. FIG. 5 is a rear view illustrating a state in which a seat belt device is installed on a seat frame according to an example of the present disclosure. FIG. 6 is a diagram illustrating a belt module of a seat belt device according to an example of the present disclosure. FIG. 7 is a diagram illustrating a drive system of a seat belt device according to an example of the present disclosure.

FIGS. 4 and 5 may be enlarged views of portion A of the chair 100 illustrated in FIG. 3 in which the seat belt device 130 is mounted. FIG. 6 may be a diagram illustrating the separated first belt module 140a. The state of the belt module 140 illustrated in FIGS. 4 to 6 may be a basic state (otherwise referred to herein as an unfastened state) in which the seat belt device 130 is not fastened and the belt 141 is not drawn out.

Referring to FIGS. 4 to 7, the seat belt device 130 according to an example may include a pair of belt modules 140, a pair of sliders 150 corresponding to the pair of belt modules 140, an elastic band 160 connecting the pair of sliders 150, and fastening members 170 respectively coupled to the pair of belt modules 140.

The pair of belt modules 140 may include a first belt module 140a and a second belt module 140b provided symmetrically to each other, and the pair of sliders 150 may include a first slider 150a connected to the first belt module 140a and a second slider 150b connected to the second belt module 140b. Components included in the first belt module 140a and the second belt module 140b may be substantially the same. Also, or alternatively, the first slider 150a and the second slider 150b may have substantially the same shape and function.

In the following, the components, an interlocking structure, and a connection structure of the pair of belt modules 140 will be described based on the first belt module 140a, but the following description may be equally applied to the second belt module 140b.

The first belt module 140a may include the main body 142 and the belt 141 at least partially wound around the main body 142 and provided to be wound around or unwound from the main body 142. As described above with reference to FIGS. 1 to 3, the clip 171 of the fastening member 170 may be connected to the belt 141 of the first belt module 140a, and the buckle 172 of the fastening member 170 may be connected to the belt 141 of the belt module 140b to correspond thereto.

The main body 142 may be coupled to the backrest frame 124 so that the first belt module 140a is mounted on the seat frame 122. The main body 142 may be a component implementing the withdrawal and retraction of the belt 141. In particular, the main body 142 may be a component implementing an operation in which the withdrawal/retraction of the belt portion restraining the shoulder is linked with the withdrawal/retraction of the belt portion restraining the waist.

The main body 142 may include a bracket 143 coupled to the backrest frame 124 and a drive system 148 coupled to the bracket 143 and implementing withdrawal/retraction of the belt 141.

The bracket 143 may be fixedly coupled to the plate portion 125 of the backrest frame 124 (particularly, the rear of the plate portion 125). According to the illustrated example, the main body 142 may further include a connection plate 144 connecting the bracket 143 and the backrest frame 124. For example, the bracket 143 may be coupled to the connection plate 144, and the connection plate 144 may be coupled to the backrest frame 124. However, the configuration of the main body 142 is not limited to the illustrated example, and according to various examples, the bracket 143 may be directly coupled to the backrest frame 124, and the bracket 143 and the connection plate 144 may be provided as one component.

The bracket 143 may have a predetermined space in which the drive system 148 may be installed and at least a portion of the belt 141 may be wound. The bracket 143 may include a first portion 1431 and a second portion 1432 spaced apart from each other at a predetermined interval and facing each other and a third portion 1433 connecting lower ends (lower edges) of the first portion 1431 and the second portion 1432. For example, the first portion 1431 may be coupled to the connection plate 144 (and/or the backrest frame 124), the third portion 1433 may extend vertically from the lower end of the first portion 1431, and the second portion 1432 may extend from the third portion 1433 to be spaced apart from the first portion 1431 in parallel. The drive system 148 and the belt 141 may be disposed in a space between the first portion 1431 and the second portion 1432.

The shape of the bracket 143 is not limited to the illustrated example and may be variously modified within a range that allows the withdrawal/retraction of the belt 141 and the operation of the drive system 148.

The drive system 148 may include a first gear 145 comprising/coupled to a first protrusion (e.g., axle, shaft, spindle, etc.) on which one end of the belt 141 is fixed and at least a portion of the belt 141 extending from one end is wound, a second gear 146, engaged with the first gear 145, comprising/coupled to a second protrusion (e.g., axle, shaft, spindle, etc.) on which the other end of the belt 141 is fixed and at least a portion of the belt 141 extending from the other end is wound, and a spring 147 coupled to the first gear 145 and the bracket 143 to provide predetermined elastic force. As discussed herein, a belt wound around a gear will be understood to refer to the belt wound around a protrusion (e.g., axle, shaft, spindle, etc.) from a center/rotational axis of the gear.

The first gear 145 may be rotatably coupled to the bracket 143. The second gear 146 may be rotatably coupled to the bracket 143. The first gear 145 and the second gear 146 may be engaged and coupled so that if one of the first gear 145 or the second gear 146 rotates, the other rotates in conjunction therewith. If the first gear 145 and the second gear 146 rotate in conjunction with each other, rotation directions thereof may be opposite to each other. For example, if a rotational force for rotating in a first rotation direction is applied to the first gear 145, the rotational force applied to the first gear 145 may be transmitted to the second gear 146 to rotate the second gear 146 in a second rotation direction opposite to the first rotation direction.

A direction in which the belt 141 is wound around the first gear 145 and a direction in which the belt 141 is wound around the second gear 146 may be opposite to each other so that if the first gear 145 and the second gear 146 rotate in conjunction with each other in opposite directions, the belt 141 is simultaneously released from each of the first gear 145 and the second gear 146 or is simultaneously wound around each of the first gear 145 and the second gear 146.

A portion of the belt 141 wound around the first gear 145 may be wound in a direction in which it is unwound from the first gear 145 if the first gear 145 rotates in the first rotation direction. Correspondingly, a portion of the belt 141 wound around the second gear 146 may be wound in a direction in which it is unwound from the second gear 146 if the second gear 146 rotates in the second rotation direction opposite to the first rotation direction. In this case, if the first gear 145 rotates in the first rotation direction, the second gear 146 rotates in conjunction therewith in the second rotation direction and the belt 141 is entirely unwound from the first gear 145 and the second gear 146. Conversely, if the first gear 145 rotates in the second rotation direction, the second gear 146 rotates in conjunction therewith in the first rotation direction, and the belt 141 may be wound around both the first gear 145 and the second gear 146.

For example, with respect to the first belt module 140a, one end of the belt 141 is fixed to the first gear 145, a portion of the belt 141 extending from one end may be wound around the first gear 145 clockwise a predetermined number of times, the other end of the belt 141 maybe fixed to the second gear 146, and a portion of the belt 141 extending from the other end may be wound around the second gear 146 counterclockwise a predetermined number of times. According to this, if the user pulls the belt 141 of the first belt module 140a (and/or the clip 171 provided in the first belt module 140a) to wear the seat belt device 130, the first gear 145 may rotate clockwise and the belt 141 wound around the first gear 145 may be unwound and the second gear 146 may rotate counterclockwise and the belt 141 wound around the second gear 146 may be unwound.

The second belt module 140b may be disposed symmetrically to the first belt module 140a, and a direction in which the belt 141 is wound around the first gear 145 and the second gear 146 is opposite to the first belt module 140a, so that, contrary to the first belt module 140a, if the user pulls the belt 141 of the second belt module 140b (and/or the buckle 172 provided in the second belt module 140b) to wear the seat belt device 130, the first gear 145 may rotate counterclockwise and the belt 141 wound around the first gear 145 may be unwound and the second gear 146 may rotate clockwise and the belt 141 wound around the second gear 146 may be unwound.

The direction in which the belt 141 is wound around the first gear 145 and the second gear 146 is not limited to the illustrated example and the above description. The direction in which the belt 141 is wound may be variously modified within a range in which the belt 141 is simultaneously wound or simultaneously unwound with respect to the first gear 145 and the second gear 146 to correspond to the operation in which the first gear 145 and the second gear 146 rotate in the opposite directions if the seat belt device 130 is worn or released.

Both ends of the spring 147 may be coupled to the bracket 143 and the first gear 145, respectively, and may apply an elastic force having a predetermined magnitude between the bracket 143 and the first gear 145. If the first gear 145 rotates in the first rotation direction in which the belt 141 is unwound with respect to the bracket 143 (for example, clockwise with respect to the first belt module 140a), the spring 147 may be provided to apply elastic force (i.e., rotational restoring force) to the gear 145 in a second rotation direction opposite to the first rotation direction (e.g., counterclockwise with respect to the first belt module 140a).

For example, the spring 147 has a first end 1472 fixedly coupled to the coupling portion 1451 of the first gear 145 and a second end 1471 fixedly coupled to the bracket 143 (e.g., inner surface of the second portion 1432 of the bracket 143), so that if the first gear 145 rotates clockwise with respect to the bracket 143 in response to the withdrawal of the belt 141, the spring 147 may be elastically deformed and generate a restoring force. The restoring force of the spring 147 may act in a direction in which the belt 141 is wound so that the belt 141 returns to the state of before it was drawn out. For example, the restoring force of the spring 147 may act on the first gear 145 to rotate the first gear 145 counterclockwise.

Accordingly, if the user's external force for drawing out the belt 141 (e.g., external withdrawal force) is removed/released, the first gear 145 may rotate counterclockwise by the restoring force of the spring 147 and the belt 141 1 may be wound again around the first gear 145. Also, or alternatively, the restoring force of the spring 147 may act in the direction in which the belt 141 is wound in a state in which the buckle 172 and the clip 171 are fastened, thereby providing tension that allows the belt 141 to stably restrain the user's body.

If the seat belt device 130 is worn, the belt 141 wound around the first gear 145 may be unwound from the first gear 145 and function as a waist belt restraining the user's waist, and if the seat belt device 130 is worn, the belt 141 wound around the second gear 146 and function as a shoulder belt restraining the user's shoulders. For example, the belt 141 wound around the first gear 145 may be referred to as a waist belt portion, and the belt 141 wound around the second gear 146 may be referred to as a shoulder belt portion.

The spring 147 may include a coil spring or torsion spring. However, the type of spring 147 is not particularly limited, and the shape of spring 147 is not limited to the illustrated form. The spring 147 may be implemented in various forms that may provide a restoring force against the rotational force of the first gear 145 if the relative rotation of the first gear 145 with respect to the bracket 143 occurs.

The belt 141 may be connected to the drive system 148 of the main body 142 such that one end is coupled to the first gear 145 and the other end is coupled to the second gear 146. A portion (and/or partial section) of the belt 141 adjacent to one end fixed to the first gear 145 may be wound around the first gear 145 a predetermined number of times and may be unwound from the first gear 145 or wound again based on the rotation of the first gear 145. Also, or alternatively, a portion (and/or partial section) of the belt 141 adjacent to the other end fixed to the second gear 146 may be wound around the second gear 146 a predetermined number of times and may be unwound from the second gear 146 or wound again based on the rotation of the second gear 146.

The belt 141 may extend through the first slider 150a and the seating portion frame 123. For example, the belt 141 may be inserted into a through-hole 151 formed in the first slider 150a and a through-hole 1231 formed in the seating portion frame 123. Also, or alternatively, the clip 171 (e.g., fastening member 170) may be fitted to the belt 141.

Referring to the form in which the belt 141 is connected to other components and extends from one end of the belt 141 fixed to the first gear 145 of the first belt module 140a as a starting point, the belt 141 may be wound around the first gear 145 (e.g., clockwise) a predetermined number of times with one end fixed to the first gear 145 and then sequentially extend to pass through the through-hole 1231 of the seating portion frame 123 and the through-hole 151 of the first slider 150a. The belt 141 may extend toward the second gear 146 after passing through the first slider 150a (via the through-hole 151 of the first slider 150a), and after the belt 141 is wound around the second gear 146 clockwise a predetermined number of times, the other end of the belt 141 may be fixed to the second gear 146. Accordingly, based on the other end of the belt 141 fixed to the second gear 146, a portion of the belt 141 extending from the other end of the belt 141 may be wound around the second gear 146 counterclockwise. The clip 171 may be fitted into a portion of the belt 141 located between the seating portion frame 123 and the first slider 150a.

The belt 141 may be movable relative to the first slider 150a, the seating portion frame 123, and the clip 171. For example, if the user withdraws or retracts the belt 141, the belt 141 may move, while passing through the seating portion frame 123 and the through-hole 151 of the first slider 150a. The clip 171 may move partially on a section of the belt 141 located between the first slider 150a and the seating portion frame 123 in response to the movement of the belt 141 and fastening with the buckle 172.

The slider 150 may be coupled to the backrest frame 124 to be movable (e.g., in a vertical direction). The slider 150 may be coupled to the edge of the backrest frame 124 and may move along the edge. For example, the slider 150 may be slidably coupled to the frame portion 126 of the backrest frame 124. The slider 150 may move along the frame portion 126 in a direction (e.g., upward direction) away from the seating portion frame 123 or in a direction (e.g., downward direction) toward the seating portion frame 123.

A movement range of the slider 150 may be limited by a stopper 1262 (e.g., protrusion) provided in the backrest frame 124. For example, the frame portion 126 of the backrest frame 124 may include a lower stopper 1262 limiting a downward direction of the slider 150 and/or an upper stopper (not illustrated) limiting an upward movement of the slider 150.

The slider 150 may guide movement of the belt 141 if the belt 141 wound around the second gear 146 of the belt module 140 is unwound from the second gear 146 or wound around the second gear 146. For example, if the belt 141 is unwound from the second gear 146, the slider 150 may move in the upward direction so that the belt 141 released from the second gear 146 may wrap around the user's shoulder. In a case in which the belt 141 is wound around the second gear 146, the slider 150 may move in the downward direction so that the belt 141 may be wound around the second gear 146 again and return to the state of before being drawn out.

The slider 150 may include a first slider 150a to which the belt 141 of the first belt module 140a is connected and a second slider 150b to which the belt 141 of the second belt module 140b is connected. The slider 150 may include a through-hole 151 through which the belt 141 passes.

The slider 150 may include a ring 152 to which the elastic band 160 is connected. Both ends of the elastic band 160 may be connected to the ring 152 of the first slider 150a and/or the ring 152 of the second slider 150b. The elastic band 160 may apply elastic force between the first slider 150a and the second slider 150b in a direction in which the first slider 150a and the second slider 150b approach each other.

The first slider 150a and the second slider 150b may move in the same direction if the belt 141 is drawn out and retracted. For example, if the user pulls out the belt 141 of the first belt module 140a and the second belt module 140b to wear the seat belt device 130, both the first slider 150a and the second slider 150b may move in the upward direction. Conversely, if the user releases the seat belt device 130 and the belt 141 of each of the first belt module 140a and the second belt module 140b is retracted, both the first slider 150a and the second slider 150b may move in the upward direction.

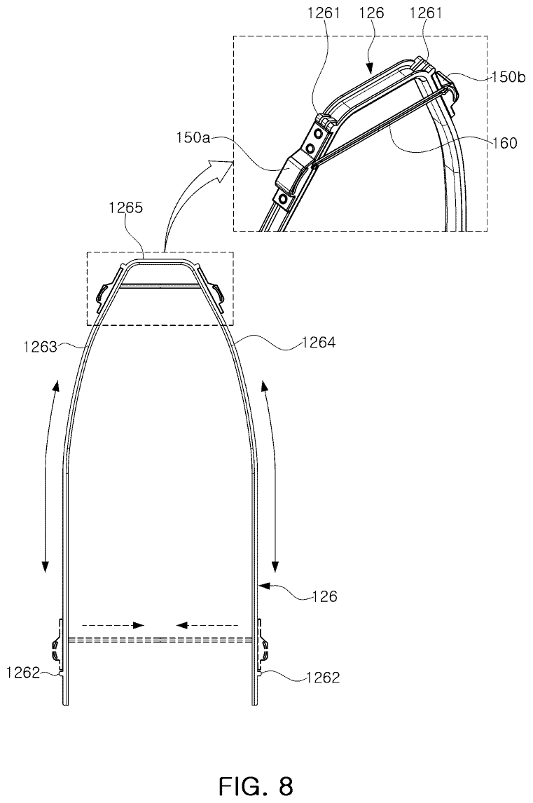

The movement of the first slider 150a and the second slider 150b may be implemented by elastic force of the elastic band 160 connecting the first slider 150a and the second slider 150b and/or elastic force of the spring 147 provided in the first belt module 140a and the second belt module 140b. The movement of the slider 150 according to the withdrawal/retraction of the belt 141 will be described in detail below with reference to FIG. 8.

FIG. 8 is a diagram illustrating an operation in which the slider of the seat belt device moves along the frame portion of the backrest frame according to an example of the present disclosure.

FIG. 8 is a diagram illustrating the movement of the first slider 150a and the second slider 150b according to the withdrawal/retraction of the belt 141. The following description of FIG. 8 also refers to FIGS. 4 to 7.

Referring to FIG. 8, the first slider 150a and the second slider 150b may move in the vertical direction along the frame portion 126 while connected to each other by an elastic band 160. The frame portion 126 of the backrest frame 124 may include a lower stopper 1262 and an upper stopper 1261. The slider 150 may contact the lower stopper 1262 to be restricted in downward movement and may contact the upper stopper 1261 to be restricted in upward movement.

As described above, the first slider 150a and the second slider 150b may be moved by elastic force of the elastic band 160 and elastic force of the spring 147 provided in the first belt module 140a and the second belt module 140b.

For example, the first slider 150a and the second slider 150b may move upwardly as force acts in a direction in which the first slider 150a and the second slider 150b approach each other by the elastic band 160 providing elastic force in the direction of contraction.

Also, or alternatively, each of the first slider 150a and the second slider 150b may move downwardly as force acts in a direction in which the first slider 150a and the second slider 150b are pulled down toward the main body 142 by the spring 147 providing elastic force in the direction in which the belt 141 is wound around the first gear 145.

The frame portion 126 may include a first portion 1263 extending in the vertical direction and to which the first slider 150a is movably connected, a second portion extending in the vertical direction and to which the second slider 150b is movably connected, and a third portion 1265 connecting upper ends of the first portion 1263 and the second portion 1264. The upper stopper 1261 may be provided at the upper end of each of the first portion 1263 and the second portion 1264, and the lower stopper 1262 may be provided at the lower end of each of the first portion 1263 and the second portion 1264.

The frame portion 126 may be formed in a shape in which the first portion 1263 and the second portion 1264 are closer upwardly. Accordingly, the first slider 150a and the second slider 150b may be moved upwardly by elastic force of the elastic band 160.

According to various examples, the frame portion 126 may be referred to as a guide rail coupled to the backrest frame 124. In the description above and the illustrated example, the frame portion 126, which is a component of the backrest frame 124, is used as a component to which the slider 150 is movably coupled. However, this is an example, and the frame portion 126 may not be a component of the backrest frame 124 but may be separately configured and provided in the form of a guide rail coupled to the plate portion 125.

Also, or alternatively, according to various examples, a guide rail to which the slider 150 is movably coupled may be provided in the plate portion 125. For example, a pair of guide rails corresponding to the pair of sliders 150 may be coupled to the rear of the plate portion 125 and extend in the vertical direction. At this time. The pair of guide rails may be closer to each other upwardly.

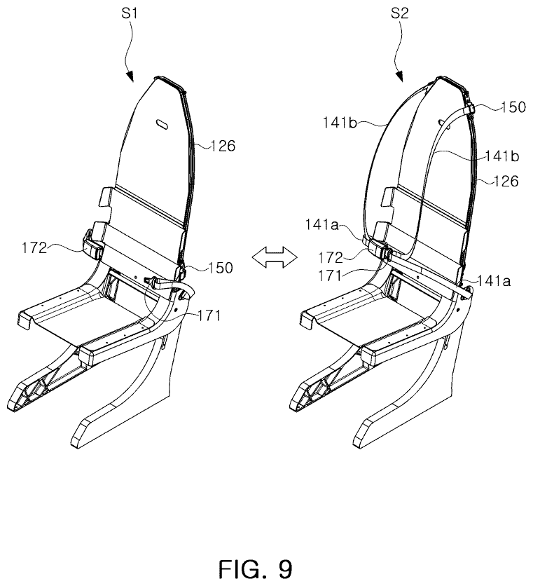

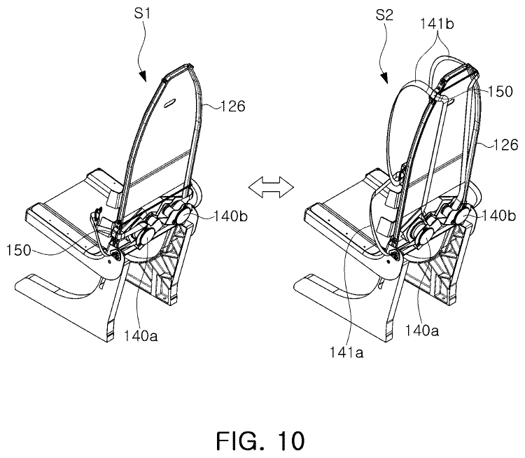

An operation of the slider 150 moving in response to the withdrawal and retraction of the belt 141 if the seat belt device 130 is worn or released and the relationship between elastic force of the spring 147 and elastic force of the elastic band 160 acting to move the slider 150 will be described in detail with reference to FIGS. 9 and 10 hereinafter.

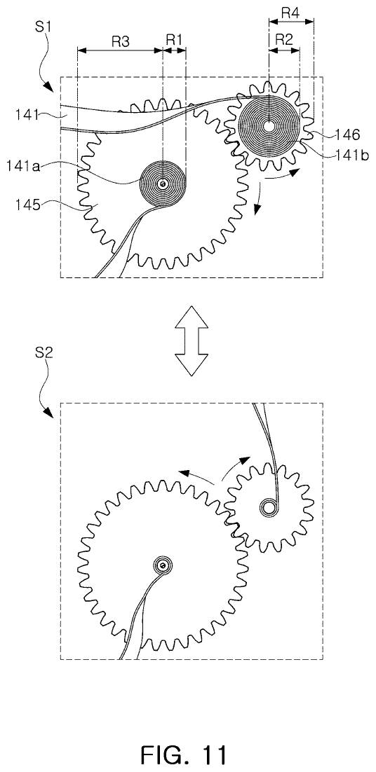

FIG. 9 is a front perspective view illustrating an operation in which a seat belt device is transformed between a basic state (otherwise referred to herein as an unfastened state) and a fastened state according to an example of the present disclosure. FIG. 10 is a rear perspective view illustrating an operation in which a seat belt device is transformed between a basic state and a fastened state according to an example of the present disclosure. FIG. 11 is a diagram illustrating an operation in which a first gear and a second gear rotate if a seat belt device is transformed between a basic state and a fastened state according to an example of the present disclosure.

The left drawings in FIGS. 9 and 10 illustrate a case in which the seat belt device 130 is in a basic state S1, and the right drawings in FIGS. 9 and 10 illustrate a case in which the seat belt device 130 is in a fastened state S2. The basic state S1 of the seat belt device 130 illustrated in FIGS. 9 and 10 may be the same as the state illustrated in FIGS. 4 and 5.

FIGS. 9 and 10 illustrate the chair 100 without the seat 110 as illustrated in FIGS. 2 and 3. FIG. 11 illustrates the first gear 145 and the second gear 146 of the first belt module 140a.

FIGS. 9 to 11 illustrate an interaction of each component according to wearing and releasing of the seat belt device 130. Hereinafter, in describing FIGS. 9 to 11, FIGS. 4 to 8 will be referred to together and a redundant description will be omitted.

The seat belt device 130 may be transformed from the basic state S1 to the fastened state S2 as the user pulls the belt 141 by applying external force and fastening the clip 171 and buckle 172, Conversely, if the clip 171 and the buckle 172 are separated and external force is removed, the belt 141 may be wound to its original state and the fastened state S2 may be transformed to the basic state S1.

If the seat belt device 130 is in the basic state S1, elastic force of the spring 147 is applied to the first gear 145 so that the waist belt portion 141a maintains a current state thereof without being unwound from the first gear 145, and elastic force of the spring 147 is greater than elastic force of the elastic band 160. As a result, if no external force (e.g., force with which the user pulls the belt 141 or force by which the belt 141 is pulled by the fastening member 170) acts on the seat belt device 130, the first gear 145 is limited in rotation in the direction in which the waist belt portion 141a is released due to elastic force of the spring 147. As the rotation of the first gear 145 is limited by elastic force of the spring 147, the rotation of the second gear 146 in the direction in which the shoulder belt portion 141b is released is also limited, and predetermined tension acts in the direction in which the shoulder belt portion 141b is wound around the second gear 146, and at this time, elastic force of the spring 147 is greater than elastic force of the elastic band 160, thereby pulling down the slider 150 downwardly, by overcoming elastic force of the elastic band 160.

That is, if the seat belt device 130 is in the basic state S1, tension acts on the waist belt portion 141a in the direction in which the waist belt portion 141a is wound around the first gear 145 due to elastic force of the spring 147, and tension acts on the shoulder belt portion 141b in the direction in which the shoulder belt portion 141b is wound around the second gear 146, and since elastic force of the spring 147 is stronger than elastic force of the elastic band 160, the force to contract the elastic band 160 cannot overcome the force by which the shoulder belt portion 141b is wound, and thus, the elastic band 160 cannot contract and the slider 150 remains in contact with the lower stopper 1262.

If the user applies external force overcoming elastic force of the spring 147 with respect to the seat belt device 130 in the basic state S1, the waist belt portion 141a is released, the first gear 145 rotates, and the second gear 146 rotates in the direction in which the shoulder belt portion 141b is released. Accordingly, tension acting on the shoulder belt portion 141b is weakened, the shoulder belt portion 141b is loosened, and elastic force of the spring 147 is offset by external force, so that only elastic force of the elastic band 160 acts, and accordingly, the first slider 150a and the second slider 150b move upward by elastic force of the elastic band 160.

The operation of the seat belt device 130 transformed from the basic state S1 to the fastened state S2 based on the interaction between the above components is described as follows.

If the user sits on the chair 100 and pulls the buckle 172 and/or the clip 171 to the center of the main body to drawn out the belt 141, the waist belt portion 141a wound around the first gear 145 of the belt module 140 is released to be drawn out, and the first gear 145 rotates. At this time, external force applied by the user while pulling the buckle 172 and the clip 171 is greater than elastic force of the spring 147 provided in the belt module 140, thereby overcoming elastic force of the spring 147 to rotate the first gear 145.

As the first gear 145 rotates, the second gear 146 engaged with the first gear 145 rotates in a direction opposite to the rotation direction of the first gear 145, and the shoulder belt portion 141b wound around the second gear 146 is released to be drawn out. If the shoulder belt portion 141b is unwound from the second gear 146, the first slider 150a and the second slider 150a move along the first portion 1263 and the second portion 1264 of the frame portion 126 in the upward direction, respectively, to become closer to each other by elastic force of the elastic band 160 acting between the first slider 150a and the second slider 150b. The first slider 150a and the second slider 150b move upwardly until they contact the upper stopper 1261. As the first slider 150a and the second slider 150b contact the upper stopper 1261 and the buckle 172 and the clip 171 are fastened, transformation to the fastened state S2 may be completed.

Based on the upward movement of the first slider 150a and the second slider 150b, the shoulder belt portion 141b may be automatically drawn out to wrap the user's waist, across the chest, up to the shoulder.

Next, the operation of the seat belt device 130 being transformed from the fastened state S2 to the basic state S1 will be described as follows.

If the user removes external force applied to the belt 141 while separating the buckle 172 and the clip 171, the first gear 145 rotates in a direction in which the waist belt portion 141a is wound by elastic force of the spring 147, and the second gear 146 is linked to the rotation of the first gear 145 to rotate in a direction in which the shoulder belt portion 141b is wound. The rotation directions of the first gear 145 and the second gear 146 are opposite to each other.

At this time, as described above, since elastic force of the spring 147 is greater than elastic force of the elastic band 160, the first slider 150a and the second slider 150b are pulled in the downward direction as the shoulder belt portion 141b is wound, and the first slider 150a and the second slider 150b move in the downward direction until they contact the lower stopper 1262. As the first slider 150a and the second slider 150b contact the lower stopper 1262 and the waist belt portion 141a and the shoulder belt portion 141b are wound to their original state, transformation to the basic state S1 may be completed.

As illustrated in FIGS. 9 and 10, the amount of withdrawal of the belt 141 for restraining the waist and the amount of withdrawal of the belt 141 for restraining the shoulders may be different. For example, a withdrawal length of the shoulder belt may be greater than a withdrawal length of the waist belt. Since the shoulder belt portion 141b and the waist belt portion 141a are drawn out by rotation of the first gear 145 and the second gear 146 being engaged with each other, a radius R3 of the first gear 145 around which the waist belt portion 141a is wound may be greater than a radius R4 of the second gear 146 around which the shoulder belt portion 141b is wound and the number of turns of the shoulder belt portion 141b may be greater than the number of turns of the waist belt portion 141a in consideration of the fact that the shoulder belt portion 141b should be drawn out long through linked rotation of the first gear 145 and the second gear 146.

The number of windings of the shoulder belt portion 141b and the number of windings of the waist belt portion 141a may be proportional to the radius in a state in which they are wound around the gears 145 and 146. For example, in the basic state S1, the radius R1 of the waist belt portion 141a wound around the first gear 145 may be smaller than the radius R2 of the shoulder belt portion 141b wound around the second gear 146.

According to various examples, if the waist belt portion 141a and the shoulder belt portion 141b are to be drawn out in the ratio of 1:X (here, X>1), the radius R3 of the first gear 145, the radius R4 of the second gear 146, the radius R1 of the waist belt portion 141a, and the radius R2 of the shoulder belt portion 141b may have a relationship as shown in Equation 1 below.

$$\frac{2 π R 3}{2 π R 1} = x \times \frac{2 π R 4}{2 π R 2} \qquad [ Equation 1 ]$$

In Equation 1 above, a ‘value obtained by dividing the circumference 2πR3 of the first gear by the circumference 2πR1 of the waist belt portion’ is X times a ‘value obtained by dividing the circumference 2πR4 of the second gear by the circumference 2πR2 of the shoulder belt portion’, and Equation 1 above may be simplified as “R3×R2=X×R4×R1”.

Equation 1 above is an example, and the present disclosure is not limited by Equation 1 above.

An aspect of the present disclosure is to provide an interlocking seat belt device having a structure in which withdrawal and retraction operations of a waist belt and a shoulder belt are linked to each other, and a device including the same.

According to an aspect of the present disclosure, a device includes a frame to which a seat is coupled and a seat belt device coupled to the frame, wherein the seat belt device includes a main body including a first gear and a second gear engaged with each other, a belt including a waist belt portion wound around the first gear and a shoulder belt portion extending from the waist belt portion and wound around the second gear, and a slider to which the belt is connected and slidably coupled to a portion of the frame.

The frame may include a backrest frame supporting a backrest of the seat, the backrest frame may include a plate portion and a frame portion surrounding an edge of the plate portion, and the slider may be slidably coupled to the frame portion and is provided to move in a vertical direction along the frame portion.

The main body may further include a bracket to which the first gear and the second gear are rotatably coupled, and a spring connecting the first gear and the bracket, and the spring may apply rotational restoring force to the first gear so that the first gear rotates in a direction in which the waist belt portion is wound with respect to the bracket.

If a first end is coupled to the first gear and a second end opposite to the first end is coupled to the bracket so that the first gear rotates in a first direction with respect to the bracket, the spring may be elastically deformed to apply rotational restoring force to the first gear in a direction opposite to the first direction.

The seat belt device may include a belt module including the main body and the belt, the belt module may include a first belt module disposed on the left of the frame and a second belt module disposed on the right of the frame, and the slider may include a first slider connected to the belt of the first belt module and a second slider connected to the belt of the second belt module.

The seat belt device may further include an elastic band connecting the first slider and the second slider, and the elastic band may generate elastic force in a direction in which the first slider and the second slider approach each other.

The rotational restoring force applied to the first gear by the spring may be greater than elastic force applied by the elastic band to the first slider and the second slider.

The frame portion of the backrest frame may include a first portion extending in a vertical direction and movably coupled to the first slider and a second portion extending in the vertical direction and movably coupled to the second slider, and a gap between the first portion and the second portion may narrow in an upward direction.

The first slider and the second slider may be provided to be movable upwardly along the first portion and the second portion, respectively, by elastic force of the elastic band.

The frame portion may include an upper stopper and a lower stopper limiting a movement range of the slider.

The seat belt device may be deformable between a basic state in which the slider is in contact with the lower stopper and a fastened state in which the slider is in contact with the upper stopper in response to an action of external withdrawal force of drawing out the belt.

The basic state may be a state in which the external withdrawal force is removed or insufficient. In the above basic state, tension may be applied to the shoulder belt portion in a direction in which the shoulder belt portion is wound around the second gear by rotational restoring force of the spring, and the slider may be maintained in contact with the lower stopper by tension acting on the shoulder belt portion.

The seat belt device may be transformed from the basic state to the fastened state by application of the external withdrawal force having a magnitude greater than the rotational restoring force of the spring, and in the process of being transformed into the fastened state, the rotational restoring force of the spring may be offset by the external withdrawal force, and the slider is maintained in contact with the upper stopper by elastic force of the elastic band.

A clip may be connected to the belt of the first belt module, and a buckle to which the clip is fastened may be connected to the belt of the second belt module.

The first gear and the second gear may be provided to rotate in opposite directions, and the waist belt portion and the shoulder belt portion may be respectively wound around the first gear and the second gear to be simultaneously wound around or unwound based on rotation of the first gear and the second gear.

A radius of the first gear may be greater than a radius of the second gear, and a radius of the waist belt portion if wound around the first gear may be smaller than a radius of the shoulder belt portion if wound around the second gear.

The shoulder belt portion may be provided to be unwound from the second gear in conjunction with an operation of the waist belt portion unwound from the first gear, and the slider may be provided to move the shoulder belt portion to a wearing position by moving along a portion of the frame.

The seat belt device may be a four-point seat belt device restraining a waist and both shoulders of a seated user.

The frame may include a backrest frame supporting the backrest of the seat, the backrest frame may include a plate portion and a frame portion surrounding an edge of the plate portion, and the plate portion may include a guide rail on which the slider is slidably coupled.

According to another aspect of the present disclosure, a mobility device includes: a body and the device according to the example installed inside of the body.

According to another aspect of the present disclosure, a seat belt device includes: a main body including a first gear and a second gear engaged with each other, a belt including a waist belt portion wound around the first gear and a shoulder belt portion extending from the waist belt portion and wound around the second gear, and a slider to which the belt is connected and slidably coupled to a guide rail, wherein the shoulder belt portion is provided to be unwound from the second gear in conjunction with an operation of the waist belt portion unwound from the first gear, and the slider is provided to move the shoulder belt portion to a wearing position by moving along the guide rail.

According to an example of the present disclosure, the shoulder belt portion is drawn out in conjunction with a single operation of drawing out the waist belt portion, and thus, the four-point belt may be easily fastened and worn and user convenience may be improved.

While examples have been illustrated and described above, it will be apparent to those skilled in the art that modifications and variations could be made without departing from the scope of the present disclosure as defined by the appended claims.

What is claimed is:

1. A device comprising:
a frame configured to be coupled to a seat; and
a seat belt device coupled to the frame,
wherein the seat belt device comprises:
a main body comprising a first gear and a second gear engaged with each other;
a belt comprising a waist belt portion wound around a first protrusion of the first gear and a shoulder belt portion extending from the waist belt portion and wound around a second protrusion of the second gear; and
a slider, to which the belt is connected, slidably coupled to a portion of the frame.

2. The device of claim 1, wherein:
the frame comprises a backrest frame configured to support a backrest of the seat,
the backrest frame comprises a plate portion and a frame portion surrounding an edge of the plate portion, and
the slider is slidably coupled to the frame portion and is configured to move in a vertical direction along the frame portion.

3. The device of claim 2, wherein:
the main body further comprises:
a bracket to which the first gear and the second gear are rotatably coupled, and
a spring connecting the first gear and the bracket, and
the spring is configured to apply a rotational restoring force to the first gear to cause the first gear to rotate, with respect to the bracket, in a direction in which the waist belt portion is wound.

4. The device of claim 3, wherein:
a first end of the spring is coupled to the first gear and a second end, opposite to the first end, of the spring is coupled to the bracket so that, based on the first gear rotating in a first direction with respect to the bracket, the spring is elastically deformed, which generates a rotational restoring force to the first gear in a direction opposite to the first direction.

5. The device of claim 3, wherein:
the main body further comprises: a third gear and a fourth gear engaged with each other and positioned in a horizontal direction relative to the first gear and the second gear;
the seat belt device further comprises a second belt comprising a second waist belt portion wound around a third protrusion from the third gear and a second shoulder belt portion extending from the second waist belt portion and wound around a fourth protrusion from the fourth gear; and
the slider comprises a first slider connected to the belt and a second slider connected to the second belt.

6. The device of claim 5, wherein:
the seat belt device further comprises an elastic band connecting the first slider and the second slider, and
the elastic band is configured to generate an elastic force in a direction in which the first slider and the second slider are configured approach each other if sliding along the frame.

7. The device of claim 6, wherein the rotational restoring force applied to the first gear by the spring is sufficient to counteract the elastic force applied by the elastic band to the first slider and the second slider.

8. The device of claim 6, wherein:
the frame portion of the backrest frame comprises:
a first portion extending in the vertical direction and movably coupled to the first slider and a second portion extending in the vertical direction and movably coupled to the second slider, wherein a gap between the first portion and the second portion narrows in an upward direction.

9. The device of claim 8, wherein the elastic force of the elastic band is configured to cause the first slider and the second slider to move upward along the first portion and the second portion, respectively.

10. The device of claim 6, wherein the frame portion comprises:
an upper stopper configured to limit upward movement of the slider, and
a lower stopper configured to limit downward movement of the slider.

11. The device of claim 10, wherein the seat belt device is configured to adopt an unfastened state in which the slider is in contact with the lower stopper and a fastened state in which, based on a withdrawal force of drawing out the belt, the slider is in contact with the upper stopper.

12. The device of claim 11, wherein, in the unfastened state:
the rotational restoring force of the spring causes tension to be applied to the shoulder belt portion in a direction in which the shoulder belt portion is wound around the second gear,
no withdrawal force sufficient to overcome the tension is applied, and
the tension causes the slider to be in contact with the lower stopper.

13. The device of claim 11, wherein:
the seat belt device is configured to transition, based on the withdrawal force being sufficient to counteract the rotational restoring force of the spring, from the unfastened state to the fastened state, and
in the fastened state, the elastic force of the elastic band causes the slider to be in contact with the upper stopper.

14. The device of claim 5, wherein
a clip is connected to the belt, and
a buckle, to which the clip is configured to be fastened, is connected to the second belt.

15. The device of claim 1, wherein:
the first gear and the second gear are configured to rotate in opposite directions, and
the waist belt portion and the shoulder belt portion are respectively wound around the first protrusion of the first gear and the second protrusion of the second gear such that the waist belt portion and the shoulder belt portion are configured to, based on rotation of the first gear and the second gear, be simultaneously wound or simultaneously unwound.

16. The device of claim 1, wherein:
a radius of the first gear is greater than a radius of the second gear, and
a radius of the waist belt portion wound around the first protrusion of the first gear is smaller than a radius of the shoulder belt portion wound around the second protrusion of the second gear.

17. The device of claim 1, wherein:
the shoulder belt portion is configured to be unwound from the second gear in conjunction with the waist belt portion being unwound from the first gear, and
the slider is configured to, by moving along the frame, move the shoulder belt portion to a wearing position.

18. The device of claim 1, wherein:
the frame comprises a backrest frame configured to support a backrest of the seat,
the backrest frame comprises a plate portion and a frame portion surrounding an edge of the plate portion, and
the plate portion comprises a guide rail on which the slider is slidably coupled.

19. A mobility device comprising:
a body; and
the device according to claim 1 installed inside of the body.

20. A seat belt device comprising:
a main body comprising a first gear and a second gear engaged with each other;
a belt comprising a waist belt portion wound around a first protrusion of the first gear and a shoulder belt portion extending from the waist belt portion and wound around a second protrusion of the second gear; and
a slider, to which the belt is connected, slidably coupled to a guide rail,
wherein the shoulder belt portion is configured to be unwound from the second protrusion of the second gear in conjunction with the waist belt portion being unwound from the first protrusion of the first gear, and
the slider is configured to, by moving along the guide rail, move the shoulder belt portion to a wearing position.
